(19) United States
(12) Patent Application Publication
(10) Pub. No.: US 2020/0121966 A1
(43) Pub. Date: Apr. 23, 2020

(54) FIREFIGHTING REDUCER STRUCTURE

(71) Applicant: SEUNGJIN IND. CO., LTD., Gyeonggi-do (KR)

(72) Inventor: Woon Taek Jung, Gyeonggi-do (KR)

(73) Assignee: SEUNGJIN IND. CO., LTD., Gyeonggi-do (KR)

(21) Appl. No.: 16/600,991

(22) Filed: Oct. 14, 2019

(30) Foreign Application Priority Data
Oct. 23, 2018 (KR) 10-2018-0126767

(51) Int. Cl. A62C 35/68

(52) U.S. Cl. CPC A62C 35/68

(57) ABSTRACT

Disclosed is a firefighting reducer structure including an adjustment pipe formed in a cylindrical shape, the adjustment pipe extending from one end to the other end thereof in a longitudinal direction of the cylinder, a connection pipe formed in a cylindrical shape, the connection pipe being fixed to the one end of the adjustment pipe, a housing pipe formed in a cylindrical shape, the housing pipe being configured to accommodate the adjustment pipe in the vicinity of the connection pipe, and a junction pipe formed in a cylindrical shape, the junction pipe being located between the adjustment pipe and the housing pipe in the longitudinal direction of the cylindrical adjustment pipe, the junction pipe being exposed in the vicinity of the housing pipe so as to cover the tip end of the housing pipe perpendicularly to the longitudinal direction of the cylindrical adjustment pipe.

### BACKGROUND OF THE INVENTION

### Field of the Invention

The present invention relates to a firefighting reducer structure capable of adjusting the position of a sprinkler head in a firefighting piping system of a building.

### Description of the Related Art

In general, a sprinkler head is disposed at a firefighting piping system installed in a ceiling of a building to sense an increase in temperature through a fusible portion of the sprinkler head when a fire breaks out, to melt or rupture the fusible portion, and to discharge pressurized water stored in a main pipe of the firefighting piping system outside, thereby automatically extinguishing the fire.

The principle purpose of the sprinkler head is to extinguish a fire in an early stage when the fire breaks out. Here, the sprinkler head is connected to a branch pipe, which diverges from the main pipe of the firefighting piping system, which is hidden by the ceiling of the building, so as to be exposed from the ceiling of the building.

Meanwhile, an example of the sprinkler head is disclosed in Korean Patent Application Publication No. 10-2008-0093218 entitled HEIGHT ADJUSTMENT PIPE MEMBER FOR SPRINKLER HEADS, wherein the height adjustment pipe member includes a connection pipe, a rubber packing, a nut, an adjustment pipe, and a sprinkler head.

The connection pipe accommodates a portion of the adjustment pipe without screw engagement so as to contact an O-ring of the adjustment pipe, and the remaining portion of the adjustment pipe is exposed. The sprinkler head is screw-engaged with the remaining portion of the adjustment pipe. Here, the rubber packing is located under the connection pipe between the connection pipe and the adjustment pipe. The nut surrounds the rubber packing and the connection pipe, and is screw-engaged with the connection pipe while deforming the rubber packing.

In order to adjust the height of the sprinkler head from the ceiling of the building after the connection pipe is coupled to the branch pipe, which diverges from the main pipe of the firefighting piping system, it is necessary to appropriately unfasten the nut from the connection pipe and then to move the adjustment pipe relative to the connection pipe of the height adjustment pipe member.

However, movement of the adjustment pipe relative to the connection pipe makes it difficult to minutely move the adjustment pipe in the connection pipe, and the height of the sprinkler head from the ceiling of the building varies depending on the level of skill of a worker. In addition, the external appearance of the height adjustment pipe member is limited, whereby it is difficult to minimize movement of the sprinkler head depending on the purpose of the firefighting piping system of the building.

### SUMMARY OF THE INVENTION

The present invention has been made in view of the above problems, and it is an object of the present invention to provide a firefighting reducer structure suitable for minutely adjusting movement of an adjustment pipe relative to a housing pipe and minimizing movement of a sprinkler head depending on the purpose of a firefighting piping system of a building.

In accordance with the present invention, the above and other objects can be accomplished by the provision of a firefighting reducer structure including an adjustment pipe formed so as to have the shape of a cylinder, the adjustment pipe extending from one end to the other end thereof in a longitudinal direction of the cylinder, a connection pipe formed so as to have the shape of a cylinder, the connection pipe being fixed to the one end of the adjustment pipe, a housing pipe formed so as to have the shape of a cylinder, the housing pipe being configured to accommodate the adjustment pipe in the vicinity of the connection pipe, and a junction pipe formed so as to have the shape of a cylinder, the junction pipe being located between the adjustment pipe and the housing pipe in the longitudinal direction of the cylinder of the adjustment pipe, the junction pipe being exposed in the vicinity of the housing pipe so as to cover a tip end of the housing pipe perpendicularly to the longitudinal direction of the cylinder of the adjustment pipe, wherein the adjustment pipe is screw-engaged with the junction pipe between the one end and the other end thereof in the longitudinal direction of the cylinder so as to be movable relative to the housing pipe.

A body of the adjustment pipe may be configured to define a hollow portion extending straight in the longitudinal direction of the cylinder inside, to have a plurality of steps formed at the one end of the adjustment pipe so as to be gradually enlarged from an edge to a middle region of the adjustment pipe outside, to have a first thread formed between the one end and the other end of the adjustment pipe outside, and to have a separation prevention protrusion protruding from the other end of the adjustment pipe toward the housing pipe outside.

The steps may be configured to individually surround an outer sidewall of the body of the adjustment pipe at the one end of the adjustment pipe so as to have same outer diameters.

The first thread may be formed along an outer sidewall of the body of the adjustment pipe in the vicinity of the steps so as to be located higher than the steps and to be lower than the separation prevention protrusion.

The separation prevention protrusion may be configured to contact an inner sidewall of a body of the housing pipe while surrounding an outer sidewall of the body of the adjustment pipe and to contact the junction pipe between the adjustment pipe and the housing pipe.

The firefighting reducer structure may further include at least one O-ring disposed between the adjustment pipe and the housing pipe, wherein the separation prevention protrusion may have at least one ring settlement groove formed in a middle region thereof, the at least one O-ring being accommodated in the at least one ring settlement groove such that the separation prevention protrusion contacts an inner sidewall of a body of the housing pipe together with the at least one O-ring.

The connection pipe may be fitted onto the outermost step, which is one of the steps of the adjustment pipe, and may be fixed thereto.

A body of the connection pipe may be configured to define a hollow portion extending straight in the longitudinal direction of the cylinder of the adjustment pipe inside, to have tightening recesses, to which external force is applied through a wrench, outside, and to have a second thread formed inside or outside.

The tightening recesses of the connection pipe may be located on the outermost step, which is one of the steps of the adjustment pipe, in a symmetrical fashion so as to be located on an outer sidewall of the body of the connection pipe.

When located at an outer sidewall of the body of the connection pipe, the tightening recesses and the second thread of the connection pipe may be located so as to be sequentially far away from the outermost step, which is one of the steps of the adjustment pipe.

When located at an outer sidewall and an inner sidewall of the body of the connection pipe, respectively, the tightening recesses and the second thread of the connection pipe may be located so as to be sequentially far away from the outermost step, which is one of the steps of the adjustment pipe.

The second thread of the connection pipe may be formed at an inner sidewall of the body of the connection pipe in the shape of a female thread or may be formed at an outer sidewall of the body of the connection pipe in the shape of a male thread such that the connection pipe is screw-engaged with a joint of at least one of a T-type steel pipe or a bellows pipe in a firefighting piping system.

The connection pipe may have a smaller length than the adjustment pipe when viewed in the longitudinal direction of the cylinder of the adjustment pipe.

The tip end of the housing pipe may be located between the one end and the other end of the adjustment pipe according to movement of the adjustment pipe relative to the housing pipe.

A body of the housing pipe may be configured to define a hollow portion extending in the longitudinal direction of the cylinder of the adjustment pipe inside, to have a large diameter portion, an inclined portion, and a small diameter portion sequentially formed in a direction far away from the other end of the adjustment pipe, and to accommodate the adjustment pipe through the large diameter portion of the housing pipe.

The large diameter portion of the housing pipe may include a third thread located at an inner sidewall of the body of the housing pipe in the vicinity of the tip end of the housing pipe and a fastening hole formed through the body of the housing pipe via the third thread.

The third thread of the housing pipe may be screw-engaged with the junction pipe between the adjustment pipe and the housing pipe.

A fastening tool may be screw-engaged into a sidewall of the housing pipe defining the fastening hole through the fastening hole while being disposed in the fastening hole such that the fastening tool contacts the junction pipe.

The small diameter portion of the housing pipe may have a fourth thread formed at the inner sidewall of the body of the housing pipe in the shape of a female thread or formed at an outer sidewall of the body of the housing pipe in the shape of a male thread so as to be screw-engaged with a sprinkler head in a firefighting piping system.

The housing pipe may have a larger length than the adjustment pipe when viewed in the longitudinal direction of the cylinder of the adjustment pipe.

The large diameter portion of the housing pipe may further include a plurality of angled external appearance portions located at a ring-shaped external appearance portion along an outer sidewall of the body of the housing pipe.

The outer sidewall of the body of the housing pipe may be securely surrounded by an auxiliary support, which is fixed to a building, and a center bracket, through which the auxiliary support is inserted, through the large diameter portion of the housing pipe, and the angled external appearance portions may contact the circumference of an insertion port located at a central region of the center bracket.

The large diameter portion of the housing pipe may further include a fifth thread formed along an outer sidewall of the body of the housing pipe, and the fifth thread may extend so as to pass the vicinity of a fastening hole of the housing pipe.

The firefighting reducer structure may further include a fixing member configured to surround the large diameter portion of the housing pipe in a shape of wings, wherein a body of the fixing member may be configured to define a first circle at a central region thereof and second circles, each of which is smaller than the first circle, at opposite-end edges thereof and to have a sixth thread formed at a sidewall defining the first circle.

The first circle of the fixing member may be fitted onto the large diameter portion of the housing pipe along the outer sidewall of the body such that the housing pipe and the fixing member are screw-engaged with each other through the fifth thread and the sixth thread, and the housing pipe and the fixing member may be fastened to a structure on a ceiling of a clean room by inserting screws through the second circles of the fixing member in order to constitute a firefighting piping system in a semiconductor manufacturing factory.

The junction pipe may be configured to be screw-engaged with the adjustment pipe between the one end and the other end of the adjustment pipe for movement of the adjustment pipe and the housing pipe relative to each other and to contact the connection pipe in the vicinity of the one end of the adjustment pipe and the separation prevention protrusion of the adjustment pipe in the vicinity of the other end of the adjustment pipe according to the movement of the adjustment pipe and the housing pipe relative to each other.

A body of the junction pipe may be configured to define a hollow portion extending straight in the longitudinal direction of the cylinder of the adjustment pipe inside and to protrude further at the tip end of the housing pipe than between the adjustment pipe and the housing pipe so as to form a T-shape outside.

The body of the junction pipe may be configured to have a seventh thread formed at an inner sidewall thereof so as to be screw-engaged with the first thread of the adjustment pipe and to have an eighth thread formed at an outer sidewall thereof so as to be screw-engaged with the third thread of the housing pipe.

Each of the adjustment pipe, the connection pipe, the housing pipe, and the junction pipe may be coated by electrodeposition or may be plated with metal for rust prevention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view showing a firefighting reducer structure according to a first embodiment of the present invention;

FIG. 2 is a sectional view showing the firefighting reducer structure of FIG. 1;

FIG. 3 is a sectional view showing an adjustment pipe in the firefighting reducer structure of FIG. 2;

FIG. 4A is a perspective view showing a connection pipe in the firefighting reducer structure of FIG. 2;

FIG. 4B is a sectional view showing the connection pipe in the firefighting reducer structure of FIG. 2;

FIG. 5 is a sectional view showing a modification of the connection pipe of FIG. 4B;

FIG. 6 is a schematic view showing an O-ring in the firefighting reducer structure of FIG. 2;

FIG. 7A is a perspective view showing a housing pipe in the firefighting reducer structure of FIG. 2;

FIG. 7B is a sectional view showing the housing pipe in the firefighting reducer structure of FIG. 2;

FIG. 8A is a side view showing a junction pipe in the firefighting reducer structure of FIG. 2;

FIG. 8B is a sectional view showing the junction pipe in the firefighting reducer structure of FIG. 2;

FIG. 9 is a plan view showing a firefighting reducer structure according to a second embodiment of the present invention;

FIG. 10 is a perspective view showing a housing pipe in the firefighting reducer structure of FIG. 9;

FIG. 11 is a plan view showing a firefighting reducer structure according to a third embodiment of the present invention;

FIG. 12 is a sectional view showing a housing pipe in the firefighting reducer structure of FIG. 11;

FIG. 13 is a perspective view showing a fixing member in the firefighting reducer structure of FIG. 11; and

FIGS. 14 to 18 are schematic views illustrating a method of using the firefighting reducer structure of FIG. 1, 9, or 11.

### DETAILED DESCRIPTION OF THE INVENTION

Reference will now be made in detail to the preferred embodiments of the present invention, examples of which are illustrated in the accompanying drawings.

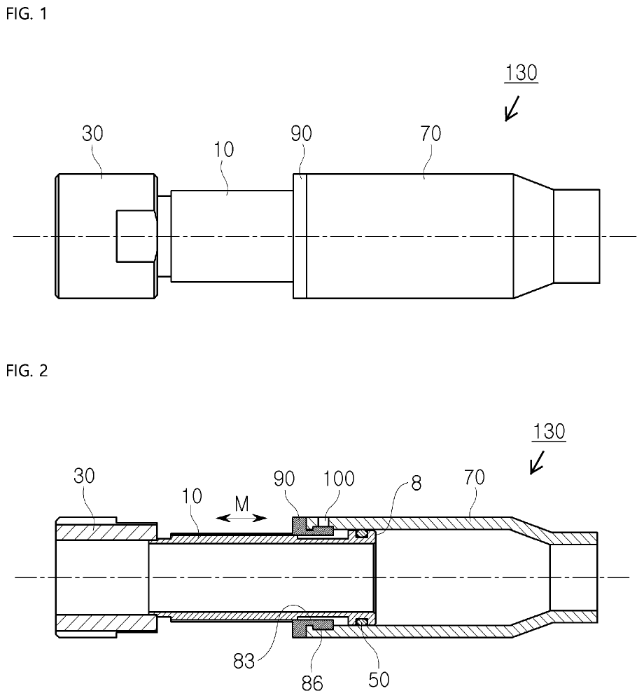

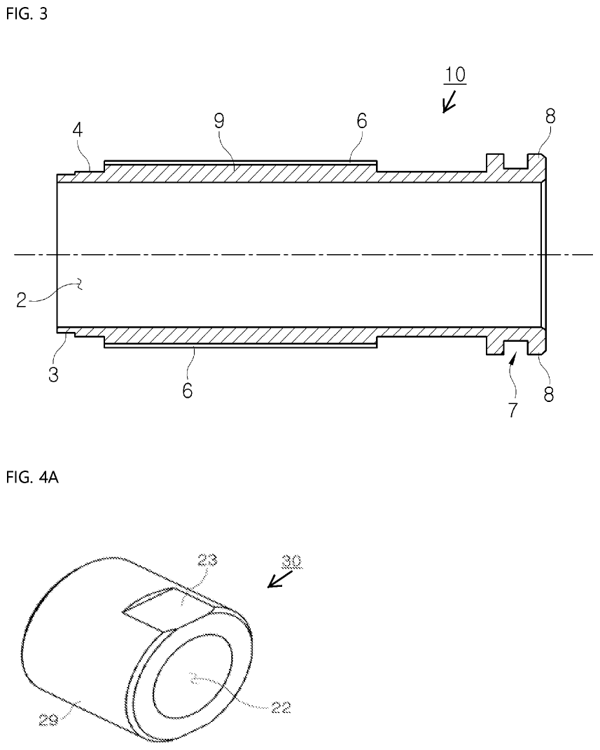

Referring to FIGS. 1 to 8, a firefighting reducer structure 130 according to a first embodiment of the present invention includes an adjustment pipe 10, a connection pipe 30, a housing pipe 70, and a junction pipe 90, as shown in FIG. 1 or 2. The adjustment pipe 10, the connection pipe 30, the housing pipe 70, and the junction pipe 90 are coupled to each other so as to have the same central axes. First, the adjustment pipe 10 is formed so as to have the shape of a cylinder, and extends from one end to the other end thereof in the longitudinal direction of the cylinder, as shown in FIG. 3.

In FIG. 3, one end of the adjustment pipe 10 is referred to as the left end. In FIG. 3, the other end of the adjustment pipe 10 is referred to as the right end. A body 9 of the adjustment pipe 10 defines a hollow portion 2 extending straight in the longitudinal direction of the cylinder inside, and has a plurality of steps 4 formed at one end of the adjustment pipe 10 so as to be gradually enlarged from the edge to the middle region of the adjustment pipe 10 outside, as shown in FIG. 3.

In addition, the body 9 of the adjustment pipe 10 has a first thread 6 (see FIG. 3) formed between one end and the other end of the adjustment pipe 10 outside, and has a separation prevention protrusion 8 (see FIG. 2 or 3) protruding from the other end of the adjustment pipe 10 toward the housing pipe 70 outside.

The steps 4 individually surround an outer sidewall of the body 9 of the adjustment pipe 10 at one end of the adjustment pipe 10 so as to have the same outer diameters. The first thread 6 is formed along the outer sidewall of the body 9 of the adjustment pipe 10 in the vicinity of the steps 4 so as to be located higher than the steps 4 and to be lower than the separation prevention protrusion 8.

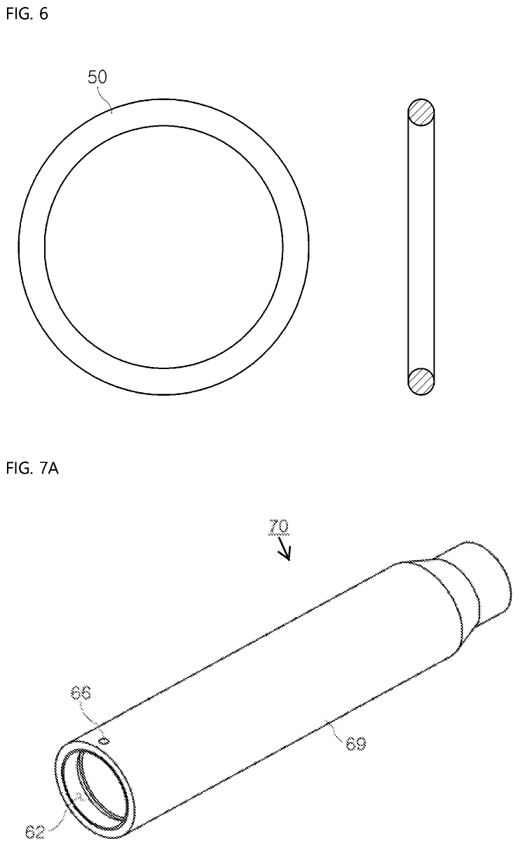

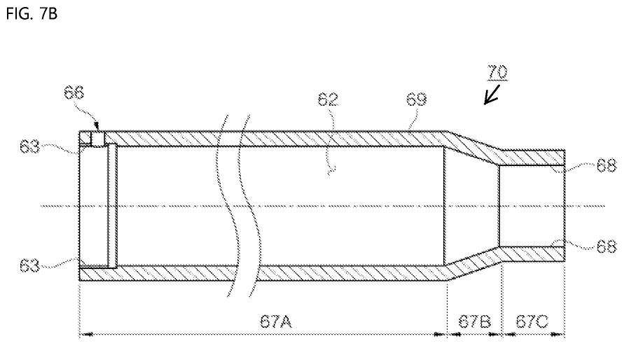

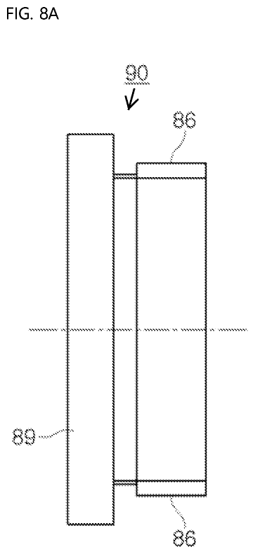

Referring to FIG. 2, the separation prevention protrusion 8 contacts an inner sidewall of a body 69 (see FIG. 7B of the housing pipe 70 while surrounding the outer sidewall of the body 9 of the adjustment pipe 10, and contacts the junction pipe 90 between the adjustment pipe 10 and the housing pipe 70, as shown in FIG. 2, 14, or 15. Referring to FIG. 2, the firefighting reducer structure 130 further includes an O-ring 50 disposed between the adjustment pipe 10 and the housing pipe 70, as shown in FIG. 6.

The separation prevention protrusion 8 has a ring settlement groove 7 formed in the middle region thereof, as shown in FIG. 3, and the O-ring 50 is accommodated in the ring settlement groove 7, whereby the separation prevention protrusion 8 contacts the inner sidewall of the body 69 of the housing pipe 70 together with the O-ring 50, as shown in FIG. 2. Here, the separation prevention protrusion 8 may have a plurality of ring settlement grooves 7 formed in the middle region thereof, and O-rings 50 corresponding in number to the number of ring settlement grooves 7 may be provided at the separation prevention protrusion 8.

The adjustment pipe 10 is screw-engaged with the junction pipe 90 between one end and the other end thereof in the longitudinal direction of the cylinder so as to be movable relative to the housing pipe 70, as shown in FIG. 2. The connection pipe 30 is formed so as to have the shape of a cylinder, and is fixed to one end of the adjustment pipe 10, as shown in FIG. 1.

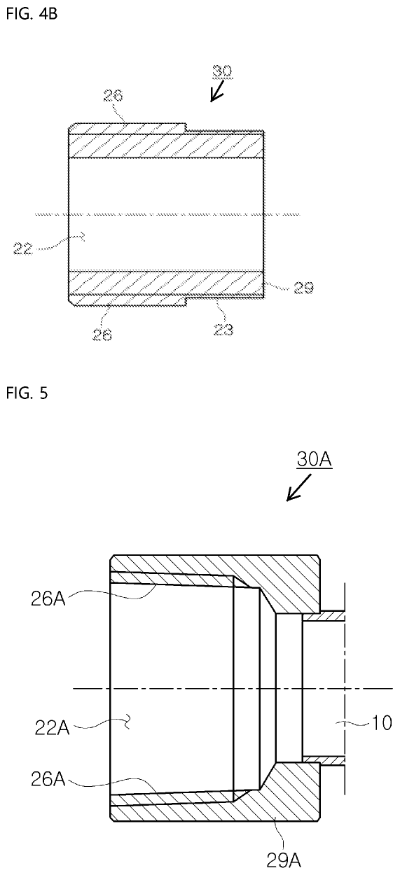

The connection pipe 30 is fitted onto the outermost step 3, which is one of the steps 4 of the adjustment pipe 10, and is fixed thereto, as shown in FIG. 2. A body 29 of the connection pipe 30 defines a hollow portion 22 extending straight in the longitudinal direction of the cylinder of the adjustment pipe 10 inside, has tightening recesses 23, to which external force is applied through a wrench, outside, and has a second thread 26 formed outside, as shown in FIGS. 4A and 4B.

The tightening recesses 23 of the connection pipe 30 are located on the outermost step 3, which is one of the steps 4 of the adjustment pipe 10, in a symmetrical fashion so as to be located on an outer sidewall of the body 29 of the connection pipe 30, as shown in FIG. 4A. When located at the outer sidewall of the body 29 of the connection pipe 30, as shown in FIG. 4B, the tightening recesses 23 and the second thread 26 of the connection pipe 30 are located so as to be sequentially far away from the outermost step 3, which is one of the steps 4 of the adjustment pipe 10, as shown in FIG. 2.

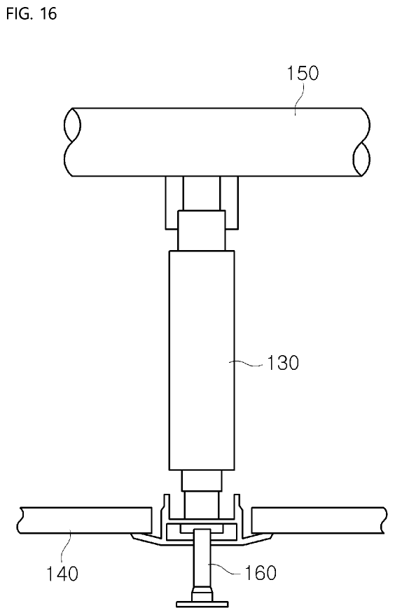

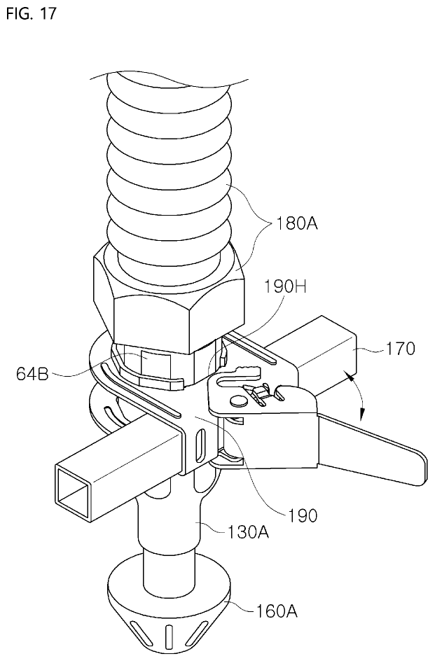

The second thread 26 of the connection pipe 30 is formed at outer sidewall of the body 29 of the connection pipe 30 in the shape of a male thread, as shown in FIG. 4B, whereby the connection pipe 30 is screw-engaged with a joint of a T-type steel pipe 150 (see FIG. 16) in a firefighting piping system.

Alternatively, a body 29A of a connection pipe 30A may define a hollow portion 22A extending in the longitudinal direction of the cylinder of the adjustment pipe 10 inside, may have tightening recesses (not shown), to which external force is applied through a wrench, outside, and may have a second thread 26A formed inside, as shown in FIG. 5. The tightening recesses of the connection pipe 30A may have the same shape as the tightening recesses 23 of the connection pipe 30, shown in FIGS. 4A and 4B.

When located respectively at an outer sidewall and an inner sidewall of the body 29A of the connection pipe 30A, the tightening recesses and the second thread 26A of the connection pipe 30A are located so as to be sequentially far away from the outermost step 3, which is one of the steps 4 of the adjustment pipe 10, as shown in FIG. 5. The second thread 26A of the connection pipe 30A is formed at the inner sidewall of the body 29A of the connection pipe 30A in the shape of a female thread, whereby the connection pipe 30A is screw-engaged with a joint of a T-type steel pipe (not shown) in a firefighting piping system.

The connection pipe 30 or 30A has a smaller length than the adjustment pipe 10 when viewed in the longitudinal direction of the cylinder of the adjustment pipe 10, as shown in FIG. 2. The housing pipe 70 is formed so as to have the shape of a cylinder, and accommodates the adjustment pipe 10 in the vicinity of the connection pipe 30, as shown in FIG. 1 or 2. A tip end of the housing pipe 70 is located between one end and the other end of the adjustment pipe 10 according to the movement of the adjustment pipe 10 relative to the housing pipe 70, as shown in FIG. 2.

The body 69 of the housing pipe 70 defines a hollow portion 62 extending in the longitudinal direction of the cylinder of the adjustment pipe 10 inside, as shown in FIGS. 7A and 7B, has a large diameter portion 67A, an inclined portion 67B, and a small diameter portion 67C sequentially formed in a direction far away from the other end of the adjustment pipe 10, as shown in FIGS. 7A and 7B, and accommodates the adjustment pipe 10 through the large diameter portion 67A of the housing pipe 70, as shown in FIG. 2.

The large diameter portion 67A of the housing pipe 70 includes a third thread 63 located at the inner sidewall of the body 69 of the housing pipe 70 in the vicinity of the tip end of the housing pipe 70, as shown in FIG. 7B, and includes a fastening hole 66 formed through the body 69 of the housing pipe 70 via the third thread 63, as shown in FIGS. 7A and 7B.

The third thread 63 of the housing pipe 70 is screw-engaged with the junction pipe 90 between the adjustment pipe 10 and the housing pipe 70, as shown in FIGS. 2 and 7B. A fastening tool 100, such as a set screw, is screw-engaged into the sidewall of the housing pipe 70 defining the fastening hole 66 through the fastening hole 66 while being disposed in the fastening hole 66 such that the fastening tool 100 contacts the junction pipe 90, as shown in FIG. 2.

Here, the fastening tool 100 impedes movement of the junction pipe 90 between the adjustment pipe 10 and the housing pipe 70. The small diameter portion 67C of the housing pipe 70 has a fourth thread 68 formed at the inner sidewall of the body 69 of the housing pipe 70 in the shape of a female thread so as to be screw-engaged with a sprinkler head 160 (see FIG. 16) in a firefighting piping system.

Alternatively, the small diameter portion 67C of the housing pipe 70 may have a fourth thread (not shown) formed at the outer sidewall of the body 69 of the housing pipe 70 in the shape of a male thread so as to be screw-engaged with a sprinkler head (not shown) in a firefighting piping system. The housing pipe 70 has a larger length than the adjustment pipe 10 when viewed in the longitudinal direction of the cylinder of the adjustment pipe 10, as shown in FIG. 2.

Meanwhile, the junction pipe 90 is formed so as to have the shape of a cylinder, is located between the adjustment pipe 10 and the housing pipe 70 in the longitudinal direction of the cylinder of the adjustment pipe 10, and is exposed in the vicinity of the housing pipe so as to cover the tip end of the housing pipe 70 perpendicularly to the longitudinal direction of the cylinder of the adjustment pipe 10, as shown in FIG. 2.

The junction pipe 90 is screw-engaged with the adjustment pipe 10 between one end and the other end of the adjustment pipe 10 for movement of the adjustment pipe 10 and the housing pipe 70 relative to each other, and contacts the connection pipe 30 in the vicinity of one end of the adjustment pipe 10 and the separation prevention protrusion 8 of the adjustment pipe 10 in the vicinity of the other end of the adjustment pipe 10 according to the movement of the adjustment pipe 10 and the housing pipe 70 relative to each other, as shown in FIGS. 2 and 3.

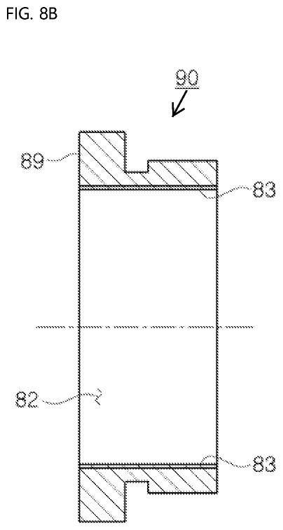

A body 89 of the junction pipe 90 defines a hollow portion 82 extending straight in the longitudinal direction of the cylinder of the adjustment pipe 10 inside, and protrudes further at the tip end of the housing pipe 70 than between the adjustment pipe 10 and the housing pipe 70 so as to form a T-shape outside, as shown in FIGS. 2, 8A, and 8B.

The body 89 of the junction pipe 90 has a seventh thread 83 formed at an inner sidewall thereof so as to be screw-engaged with the first thread 6 (see FIG. 3) of the adjustment pipe 10, as shown in FIB. 8(b), and has an eighth thread 86 formed at an outer sidewall thereof so as to be screw-engaged with the third thread 63 of the housing pipe 70, as shown in FIB. 8(a). Each of the adjustment pipe 10, the connection pipe 30, the housing pipe 70, the junction pipe 90, and the fastening tool 100 is coated by electrodeposition or is plated with metal, such as nickel (Ni) or chromium (Cr), for rust prevention.

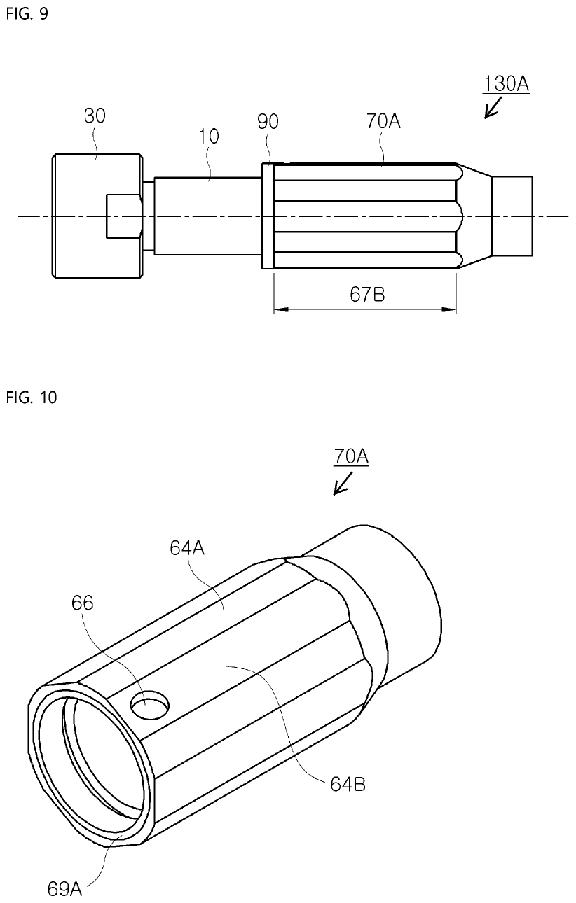

FIG. 9 is a plan view showing a firefighting reducer structure according to a second embodiment of the present invention, and FIG. 10 is a perspective view showing a housing pipe in the firefighting reducer structure of FIG. 9.

Components shown in FIGS. 9 and 10 identical to those shown in FIGS. 1 to 8 are denoted by the same reference numerals.

Referring to FIGS. 9 and 10, a firefighting reducer structure 130A according to a second embodiment of the present invention has a structure similar to the structure of the firefighting reducer structure 130 of FIGS. 1 to 8; however, a housing pipe 70A of the firefighting reducer structure 130A has a structure different from the structure of the housing pipe 70 of the firefighting reducer structure 130 shown in FIGS. 1 to 8.

That is, a large diameter portion 67B of the housing pipe 70A further includes a plurality of angled external appearance portions 64B located at a ring-shaped external appearance portion 64A along an outer sidewall of a body 69A of the housing pipe 70A, as shown in FIG. 10.

The outer sidewall of the body 69A of the housing pipe 70A is securely surrounded by an auxiliary support 170, which is fixed to a building, and a center bracket 190, through which the auxiliary support 170 is inserted, through the large diameter portion 67B of the housing pipe 70A, as shown in FIG. 17, and the angled external appearance portions 64B contact the circumference of an insertion port 190H located at the central region of the center bracket 190.

The housing pipe 70A is connected to a sprinkler head 160A under the center bracket 190, as shown in FIG. 17. Meanwhile, the firefighting reducer structure 130A is screw-engaged with a joint of a bellows pipe 180A (see FIG. 17) through the connection pipe 30.

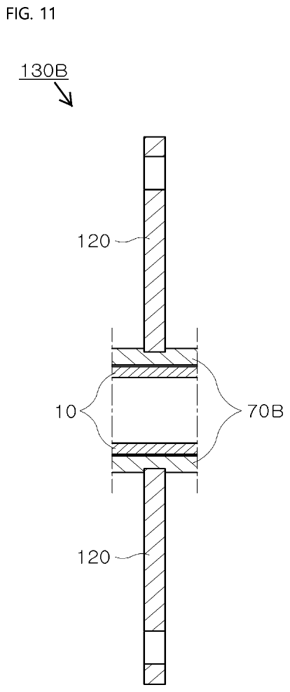

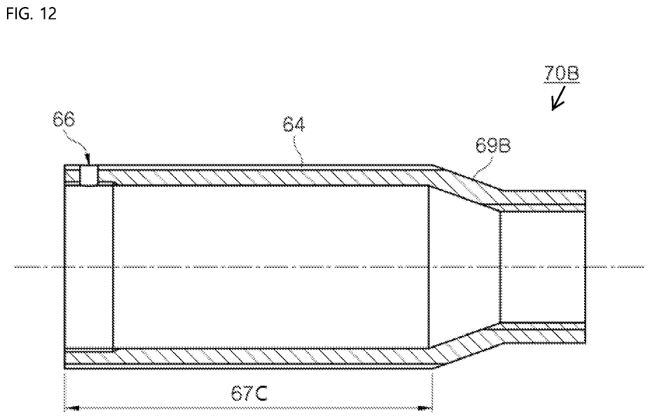

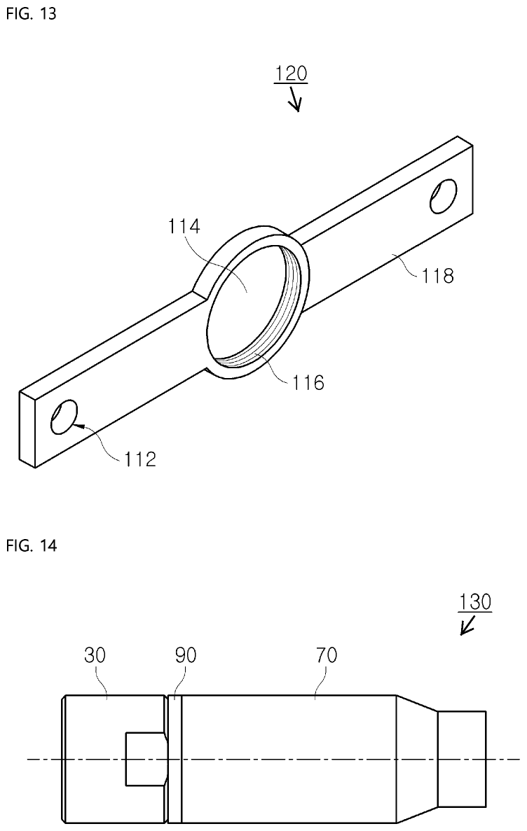

FIG. 11 is a plan view showing a firefighting reducer structure according to a third embodiment of the present invention, FIG. 12 is a sectional view showing a housing pipe in the firefighting reducer structure of FIG. 11, and FIG. 13 is a perspective view showing a fixing member in the firefighting reducer structure of FIG. 11.

Components shown in FIGS. 11 to 13 identical to those shown in FIGS. 1 to 8 are denoted by the same reference numerals.

Referring to FIGS. 11 to 13, a firefighting reducer structure 130B according to a third embodiment of the present invention has a structure similar to the structure of the firefighting reducer structure 130 of FIGS. 1 to 8; however, a housing pipe 70B of the firefighting reducer structure 130B has a structure different from the structure of the housing pipe 70 of the firefighting reducer structure 130 shown in FIGS. 1 to 8.

That is, a large diameter portion 67C of the housing pipe 70B further includes a fifth thread 64 formed along an outer sidewall of a body 69B of the housing pipe 70B, as shown in FIG. 12. The fifth thread 64 extends so as to pass the vicinity of a fastening hole 66 formed through the housing pipe 70B, as shown in FIG. 12.

Here, the firefighting reducer structure 130B further includes a fixing member 120 configured to surround the large diameter portion 67C of the housing pipe 70B in the shape of wings, as shown in FIG. 11 or 13. A body 118 of the fixing member 120 defines a first circle 114 at the central region thereof, defines second circles 112, each of which is smaller than the first circle 114, at the opposite-end edges thereof, and has a sixth thread 116 formed at a sidewall defining the first circle 114, as shown in FIG. 13.

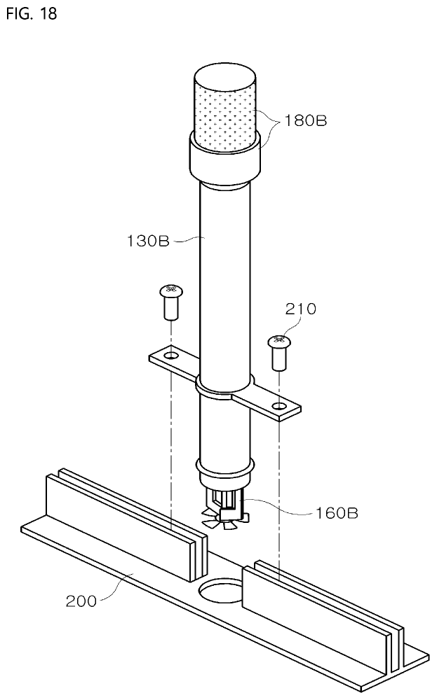

Meanwhile, the first circle 114 of the fixing member 120 is fitted onto the large diameter portion 67A of the housing pipe 70B along the outer sidewall of the body 69B such that the housing pipe 70B and the fixing member 120 are screw-engaged with each other through the fifth thread 54 and the sixth thread 116, as shown in FIGS. 11 to 13, and the housing pipe 70B and the fixing member 120 are fastened to a structure 200 (see FIG. 18) on a ceiling of a clean room by inserting screws 210 (see FIG. 18) through the second circles 112 of the fixing member 120 in order to constitute a firefighting piping system in a semiconductor manufacturing factory, as shown in FIGS. 11 to 13 and 18.

In addition, the firefighting reducer structure 130B is screw-engaged with a sprinkler head 160B through the housing pipe 70B, and is screw-engaged with a joint of a bellows pipe 180B through the connection pipe 30, as shown in FIG. 18.

FIGS. 14 to 18 are schematic views illustrating a method of using the firefighting reducer structure of FIG. 1, 9, or 11.

FIGS. 14 to 18 will be described with reference to FIGS. 1 to 13.

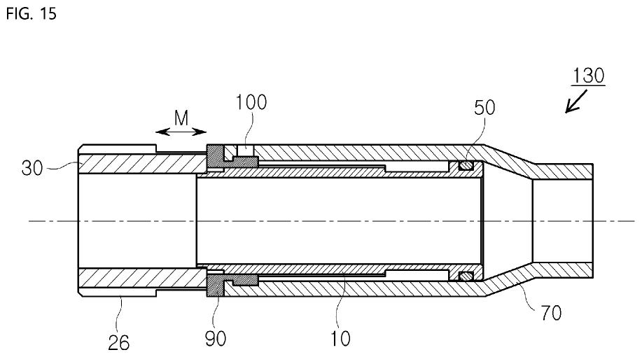

Referring to FIGS. 14 to 18, an adjustment pipe 10, a connection pipe 30, a housing pipe 70, and a junction pipe 90 may be prepared. The adjustment pipe 10, the connection pipe 30, the housing pipe 70, and the junction pipe 90 may be coupled to each other, as shown in FIGS. 1 to 8, in order to constitute a firefighting reducer structure 130, as shown in FIG. 14 or 15.

The firefighting reducer structure 130 may translate (M) the adjustment pipe 10 relative to the housing pipe 70 in the longitudinal direction of the cylinder of the adjustment pipe 10, as shown in FIG. 2 or 15. The adjustment pipe 10 may be surrounded by the housing pipe 70 and the junction pipe 90 during translation (M) thereof, as shown in FIG. 14 or 15.

In addition, the adjustment pipe 10 may be exposed from the connection pipe 30, the housing pipe 70, and the junction pipe 90 during translation (M) thereof, as shown in FIG. 1 or 2. Subsequently, the connection pipe 30 may be screw-engaged with a joint of a T-type steel pipe 150 (see FIG. 16) in a firefighting piping system of a building. Subsequently, the housing pipe 70 may be connected to a sprinkler head 160A (see FIG. 16) in the firefighting piping system. In this case, the adjustment pipe 10 is capable of minutely adjusting the height of the sprinkler head 160A from a ceiling 140 of the building using screw engagement with the junction pipe 90, since the adjustment pipe 10 is translated (M) relative to the housing pipe 70.

Meanwhile, the firefighting reducer structure 130 may be replaced by the firefighting reducer structure 130A of FIG. 9 or 17 or by the firefighting reducer structure 130B of FIG. 11 or 16. The firefighting reducer structure 130A may be surrounded by an auxiliary support 170, which is fixed to a building, and a center bracket 190, through which the auxiliary support 170 is inserted in order to positively satisfy the earthquake-proof design of the building. In addition, the firefighting reducer structure 130B may be fixed to a structure 200 on a ceiling of a clean room in a semiconductor manufacturing factory.

As is apparent from the above description, in the firefighting reducer structure according to the present invention, the junction pipe is disposed between the housing pipe and the adjustment pipe, the adjustment pipe and the junction pipe are screw-engaged with each other during movement of the adjustment pipe relative to the housing pipe, and the sprinkler head is coupled to the adjustment pipe outside the housing pipe. Consequently, it is possible to minutely move the adjustment pipe relative to the housing pipe irrespective of the level of skill of a worker, whereby it is possible to uniformly adjust the height of the sprinkler head from the ceiling of the building.

In the firefighting reducer structure according to the present invention, the angled external appearance portions are provided at the ring-shaped external appearance portion of the housing pipe, in which the adjustment pipe is accommodated, or the wing-shaped fixing member is fitted onto the outer sidewall of the housing pipe such that the fixing member is screw-engaged with the housing pipe. Consequently, it is possible to positively use the ring-shaped external appearance portion and the angled external appearance portions of the housing pipe in order to satisfy the earthquake-proof design of the building, or it is possible to securely install the structure in which the housing pipe and the fixing member are coupled to each other to the structure of the ceiling of the clean room in the semiconductor manufacturing factory.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A firefighting reducer structure comprising:
an adjustment pipe formed so as to have a shape of a cylinder, the adjustment pipe extending from one end to the other end thereof in a longitudinal direction of the cylinder;
a connection pipe formed so as to have a shape of a cylinder, the connection pipe being fixed to the one end of the adjustment pipe;
a housing pipe formed so as to have a shape of a cylinder, the housing pipe being configured to accommodate the adjustment pipe in a vicinity of the connection pipe; and
a junction pipe formed so as to have a shape of a cylinder, the junction pipe being located between the adjustment pipe and the housing pipe in the longitudinal direction of the cylinder of the adjustment pipe, the junction pipe being exposed in a vicinity of the housing pipe so as to cover a tip end of the housing pipe perpendicularly to the longitudinal direction of the cylinder of the adjustment pipe, wherein
the adjustment pipe is screw-engaged with the junction pipe between the one end and the other end thereof in the longitudinal direction of the cylinder so as to be movable relative to the housing pipe.

2. The firefighting reducer structure according to claim 1, wherein a body of the adjustment pipe is configured:
to define a hollow portion extending straight in the longitudinal direction of the cylinder inside;
to have a plurality of steps formed at the one end of the adjustment pipe so as to be gradually enlarged from an edge to a middle region of the adjustment pipe outside;
to have a first thread formed between the one end and the other end of the adjustment pipe outside; and
to have a separation prevention protrusion protruding from the other end of the adjustment pipe toward the housing pipe outside.

3. The firefighting reducer structure according to claim 2, wherein the steps are configured to individually surround an outer sidewall of the body of the adjustment pipe at the one end of the adjustment pipe so as to have same outer diameters.

4. The firefighting reducer structure according to claim 2, wherein the first thread is formed along an outer sidewall of the body of the adjustment pipe in a vicinity of the steps so as to be located higher than the steps and to be lower than the separation prevention protrusion.

5. The firefighting reducer structure according to claim 2, wherein the separation prevention protrusion is configured:
to contact an inner sidewall of a body of the housing pipe while surrounding an outer sidewall of the body of the adjustment pipe; and
to contact the junction pipe between the adjustment pipe and the housing pipe.

6. The firefighting reducer structure according to claim 2, further comprising:
at least one O-ring disposed between the adjustment pipe and the housing pipe, wherein
the separation prevention protrusion has at least one ring settlement groove formed in a middle region thereof, the at least one O-ring being accommodated in the at least one ring settlement groove such that the separation prevention protrusion contacts an inner sidewall of a body of the housing pipe together with the at least one O-ring.

7. The firefighting reducer structure according to claim 2, wherein the connection pipe is fitted onto an outermost step, which is one of the steps of the adjustment pipe, and is fixed thereto.

8. The firefighting reducer structure according to claim 7, wherein a body of the connection pipe is configured:
to define a hollow portion extending straight in the longitudinal direction of the cylinder of the adjustment pipe inside;
to have tightening recesses, to which external force is applied through a wrench, outside; and
to have a second thread formed inside or outside.

9. The firefighting reducer structure according to claim 8, wherein the tightening recesses of the connection pipe are located on an outermost step, which is one of the steps of the adjustment pipe, in a symmetrical fashion so as to be located on an outer sidewall of the body of the connection pipe.

10. The firefighting reducer structure according to claim 8, wherein
when located at an outer sidewall of the body of the connection pipe,
the tightening recesses and the second thread of the connection pipe are located so as to be sequentially far away from an outermost step, which is one of the steps of the adjustment pipe.

11. The firefighting reducer structure according to claim 8, wherein
when located at an outer sidewall and an inner sidewall of the body of the connection pipe, respectively,
the tightening recesses and the second thread of the connection pipe are located so as to be sequentially far away from an outermost step, which is one of the steps of the adjustment pipe.

12. The firefighting reducer structure according to claim 8, wherein the second thread of the connection pipe is formed at an inner sidewall of the body of the connection pipe in a shape of a female thread or is formed at an outer sidewall of the body of the connection pipe in a shape of a male thread such that the connection pipe is screw-engaged with a joint of at least one of a T-type steel pipe or a bellows pipe in a firefighting piping system.

13. The firefighting reducer structure according to claim 2, wherein the connection pipe has a smaller length than the adjustment pipe when viewed in the longitudinal direction of the cylinder of the adjustment pipe.

14. The firefighting reducer structure according to claim 2, wherein the tip end of the housing pipe is located between the one end and the other end of the adjustment pipe according to movement of the adjustment pipe relative to the housing pipe.

15. The firefighting reducer structure according to claim 2, wherein a body of the housing pipe is configured:
to define a hollow portion extending in the longitudinal direction of the cylinder of the adjustment pipe inside;
to have a large diameter portion, an inclined portion, and a small diameter portion sequentially formed in a direction far away from the other end of the adjustment pipe; and
to accommodate the adjustment pipe through the large diameter portion of the housing pipe.

16. The firefighting reducer structure according to claim 15, wherein the large diameter portion of the housing pipe comprises:
a third thread located at an inner sidewall of the body of the housing pipe in a vicinity of the tip end of the housing pipe; and
a fastening hole formed through the body of the housing pipe via the third thread.

17. The firefighting reducer structure according to claim 16, wherein the third thread of the housing pipe is screw-engaged with the junction pipe between the adjustment pipe and the housing pipe.

18. The firefighting reducer structure according to claim 16, wherein a fastening tool is screw-engaged into a sidewall of the housing pipe defining the fastening hole through the fastening hole while being disposed in the fastening hole such that the fastening tool contacts the junction pipe.

19. The firefighting reducer structure according to claim 16, wherein the small diameter portion of the housing pipe has a fourth thread formed at the inner sidewall of the body of the housing pipe in a shape of a female thread or formed at an outer sidewall of the body of the housing pipe in a shape of a male thread so as to be screw-engaged with a sprinkler head in a firefighting piping system.

20. The firefighting reducer structure according to claim 2, wherein the housing pipe has a larger length than the adjustment pipe when viewed in the longitudinal direction of the cylinder of the adjustment pipe.

21. The firefighting reducer structure according to claim 16, wherein the large diameter portion of the housing pipe further comprises a plurality of angled external appearance portions located at a ring-shaped external appearance portion along an outer sidewall of the body of the housing pipe.

22. The firefighting reducer structure according to claim 21, wherein the outer sidewall of the body of the housing pipe is securely surrounded by an auxiliary support, which is fixed to a building, and a center bracket, through which the auxiliary support is inserted, through the large diameter portion of the housing pipe, and the angled external appearance portions contact a circumference of an insertion port located at a central region of the center bracket.

23. The firefighting reducer structure according to claim 16, wherein
the large diameter portion of the housing pipe further comprises a fifth thread formed along an outer sidewall of the body of the housing pipe, and
the fifth thread extends so as to pass a vicinity of a fastening hole of the housing pipe.

24. The firefighting reducer structure according to claim 23, further comprising:
a fixing member configured to surround the large diameter portion of the housing pipe in a shape of wings, wherein
a body of the fixing member is configured:
to define a first circle at a central region thereof and second circles, each of which is smaller than the first circle, at opposite-end edges thereof; and
to have a sixth thread formed at a sidewall defining the first circle.

25. The firefighting reducer structure according to claim 24, wherein
the first circle of the fixing member is fitted onto the large diameter portion of the housing pipe along the outer sidewall of the body such that the housing pipe and the fixing member are screw-engaged with each other through the fifth thread and the sixth thread, and
the housing pipe and the fixing member are fastened to a structure on a ceiling of a clean room by inserting screws through the second circles of the fixing member in order to constitute a firefighting piping system in a semiconductor manufacturing factory.

26. The firefighting reducer structure according to claim 2, wherein the junction pipe is configured:
to be screw-engaged with the adjustment pipe between the one end and the other end of the adjustment pipe for movement of the adjustment pipe and the housing pipe relative to each other; and
to contact the connection pipe in a vicinity of the one end of the adjustment pipe and the separation prevention protrusion of the adjustment pipe in a vicinity of the other end of the adjustment pipe according to the movement of the adjustment pipe and the housing pipe relative to each other.

27. The firefighting reducer structure according to claim 16, wherein a body of the junction pipe is configured:
to define a hollow portion extending straight in the longitudinal direction of the cylinder of the adjustment pipe inside; and
to protrude further at the tip end of the housing pipe than between the adjustment pipe and the housing pipe so as to form a T-shape outside.

28. The firefighting reducer structure according to claim 27, wherein the body of the junction pipe is configured:
to have a seventh thread formed at an inner sidewall thereof so as to be screw-engaged with the first thread of the adjustment pipe; and
to have an eighth thread formed at an outer sidewall thereof so as to be screw-engaged with the third thread of the housing pipe.

29. The firefighting reducer structure according to claim 1, wherein each of the adjustment pipe, the connection pipe, the housing pipe, and the junction pipe is coated by electrodeposition or is plated with metal for rust prevention.
